(19) United States
(12) Patent Application Publication
(10) Pub. No.: US 2006/0245307 A1
(43) Pub. Date: Nov. 2, 2006

(54) Recording medium, data reproducing device, data recording device, and data reproducing method

(76) Inventors: Hirokazu So, Moriguchi City (JP); Shinji Inoue, Neyagawa City (JP); Takuji Maeda, Neyagawa City (JP); Makoto Ochi, Hirakata City (JP); Masato Suto, Neyagawa City (JP)

Correspondence Address: Randolph A Smith;Smith Patent Office, Suite 901, 1901 Pennsylvania Ave N W, Washington, DC, 20006-3433, US

(21) Appl. No.: 10/559,939

(22) PCT Filed: Jun. 8, 2004
(86) PCT No.: PCT/JP04/08304

§ 371 Date: May 9, 2006

(30) Foreign Application Priority Data
Jun. 12, 2003 (JP) 2003-167889

(51) Int. Cl. H04B 1/20

(52) U.S. Cl. 369/1

(57) ABSTRACT

A recording medium for recording digital data includes a content storage area for storing a plurality of content groups; a selector storage area for selecting one of the plurality of content groups; and a retrieved-information storage area for storing information to be retrieved. A data reproducing device switches selectors, whereby the data of all of the content groups can be reproduced in such a manner that the specification of the recording medium is conformed.

### TECHNICAL FIELD

The present invention relates to a recording medium on which digital data is recorded, a data reproducing device and data recording device which are involved in reproducing and recording of digital data, and a data reproducing method.

### BACKGROUND ART

In recent years, semiconductor memories, such as an SD memory card, smart media and compact flash memory, are becoming widely available as a recording media for storing digital data. These recording media are in wide use mainly for mobile equipment especially such as a DSC (Digital Still Camera), mobile phone, mobile audio player, mobile video viewer, and PDA (Personal Digital Assistant).

Capacities of these recording media have been larger year by year. In the case of the SD memory card, the largest capacity was 64 MB (Bytes) in the year 2000 when the card appeared on the market. However, in 2003, a card with a capacity of 512 MB was commercialized, and cards with a further larger capacity such as 1 GB or 2 GB are scheduled to be commercialized in coming years.

Moreover, using a hard disk which has already realized a capacity of hundreds of GB and the SD memory card together as a set allows a configuration of a pseudo-SD memory card with an extremely large capacity. As capacities of recording media become larger as thus described, the number of content data stored in one recording medium also increases. With this increase, it becomes necessary for all kinds of specifications describing handling of content data to be extended.

For example, when a music content is stored in a form conforming to “SD Memory Card Specifications/Part 4 AUDIO SPECIFICATIONS/Ver1.01” (hereinafter referred to as SD-AUDIO specification) as a specification concerning the SD memory card, the largest number of tracks capable of storage is restricted to 999. When one track is a compressed 1 MB audio file, the 999 tracks occupy a capacity of 999 MB. Herein, if the card has a capacity of 2 GB, the music content can be stored only in about half the area. Further, if the above-mentioned pseudo-SD memory card with an extremely large capacity is used, it can be said that the area capable of storing the music content is far smaller than the full capacity.

This condition described above is not preferable for a user who wants to use the large capacity SD memory card or the pseudo-SD memory card with an extremely large capacity, mainly for storage of music contents.

As a method for extending a conventional specification in terms of another kind of recording medium, a method for utilizing an empty area of UTOC information of an MD (Mini Disk) may be applied. This technique is disclosed in JP-A 9-55069. According to this method, it is possible to further store data other than conventional content data.

However, the above-mentioned conventional technique has following problems. The technique is not applicable for recording media such as the SD memory card having no UTOC information other than the MD. For example, this technique is not applicable for extending the current SD-AUDIO specification so as to control 1000 tracks or more. Further, there is a problem that many other items have to be additionally installed on the data reproducing device and the data recording device in order to adapt to the extended specification.

Accordingly, in view of the above-mentioned problems, it is an object of the present invention to realize a recording medium capable of storing a large number of digital data more than the number of digital data that can be handled in a conventional specification in a large capacity recording medium, while holding upward compatibility with a conventional recording medium. It is another object of the present invention to realize a method for reproducing digital data by means of the recording medium of the present invention even in a conventional data reproducing device, let alone in a new data reproducing device. It is still another object of the present invention to realize a data recording device capable of recording a large number of digital data more than the number of digital data that can be handled in a conventional specification, on a large capacity recording medium.

### DISCLOSURE OF THE INVENTION

A first recording medium of the present invention includes: a content data storage area which stores at least one of content groups conforming to an identical form; a selector storage area which stores selector information for designating one of the content groups; and a retrieved-information storage area which stores information including a record address needed when a data reproducing device extracts the content group and the selector information.

A second recording medium of the present invention includes: a content data storage area which stores at least one of content groups conforming to an identical form; and a retrieved-information storage area which stores information including a record address needed when a data reproducing device extracts the content group.

A first data reproducing device of the present invention includes: a slot into which a recording medium is inserted; a selector acquiring section which acquires a selector from a selector storage area of the first recording medium inserted into the slot; a selector updating section which updates the selector acquired from the selector acquiring section, in conformity with a content group to be reproduced; a content data acquiring section which acquires content data contained in each of content groups from the content data storage area of the first recording medium; and a content data reproducing section which reproduces the content data acquired by the content data acquiring section.

A second data reproducing device of the present invention includes: a slot into which a recording medium is inserted; a content group selecting section which selects one of content groups stored in a content data storage area of the second recording medium inserted into the slot; a content data acquiring section which acquires content data contained in each of the content groups from the content data storage area of the second recording medium; and a content data reproducing section which reproduces the content data acquired by the content data acquiring section.

In a first data reproducing method of the present invention includes the following steps of: writing information showing the content groups in the first recording medium as a selector into the selector storage area; and extracting content data of each of the content groups selected by the selector from the content data storage area and then reproducing the content data.

In a second data reproducing method of the present invention further includes the following step of: reproducing all content groups contained in the content data storage area of the second recording medium.

A first data recording device of the present invention includes: a slot into which a recording medium is inserted; a selector updating section which acquires a selector from a selector storage area of the first recording medium inserted into the slot and, also, updates the selector in conformity with a content group to be reproduced; a content data converting section which inputs content data and converts the inputted data into a content group including a file conforming to a specification of the first recording medium; and a content data recording section which records data of the content group in the content data storage area of the first recording medium.

A second data recording device of the present invention includes: a slot into which a recording medium is inserted; a content group selecting section which selects one of content groups stored in a content data storage area of the second recording medium inserted into the slot; a content data converting section which inputs content data and converts the inputted data into a content group including a file conforming toga specification of the second recording medium; and a content data recording section which records data of the content group in the content data storage area of the second recording medium.

### BRIEF DESCRIPTION OF THE DRAWINGS

FIG. 1 is a view showing an example of a data structure of a recording medium in Embodiment 1 of the present invention.

FIG. 2 is a view showing an example of a data structure concerning the SD-AUDIO specification of a conventional recording medium.

FIG. 3 is an explanatory view showing an example of a data structure concerning the SD-AUDIO specification of the recording medium in Embodiment 1 of the present invention.

FIG. 4 is an explanatory view showing a specific example of a selector storage area in Embodiment 1 of the present invention.

FIG. 5 is a block diagram of a data reproducing device in Embodiment 1 of the present invention.

FIG. 6 is a block diagram of a conventional data reproducing device.

FIG. 7 is a sequence diagram of a content data reproducing method in Embodiment 1 of the present invention.

FIG. 8 is an explanatory view of a transition state at updating a directory in Embodiment 1 of the present invention.

FIG. 9 is a block diagram of a main part of a data recording device in Embodiment 1 of the present invention.

FIG. 10 is an explanatory view of an example where information of a link list is recorded in a content data list in Embodiment 1 of the present invention.

FIG. 11 is a sequence diagram of a content data reproducing method using a user identifier in Embodiment 1 of the present invention.

FIG. 12 is an explanatory view showing an example of a data structure of a recording medium in Embodiment 2 of the present invention.

FIG. 13 is an explanatory view showing an example of a data structure concerning the SD-AUDIO specification of the recording medium in Embodiment 2 of the present invention.

FIG. 14 is a block diagram of a data reproducing device in Embodiment 2 of the present invention.

FIG. 15 is a sequence diagram of a content data reproducing method using a user identifier in Embodiment 2 of the present invention.

FIG. 16 is a block diagram of a main part of a data recording device in Embodiment 2 of the present invention.

### BEST MODE FOR CARRYING OUT THE INVENTION

In the following description, embodiments of the present invention are specifically described based upon drawings.

### Embodiment 1

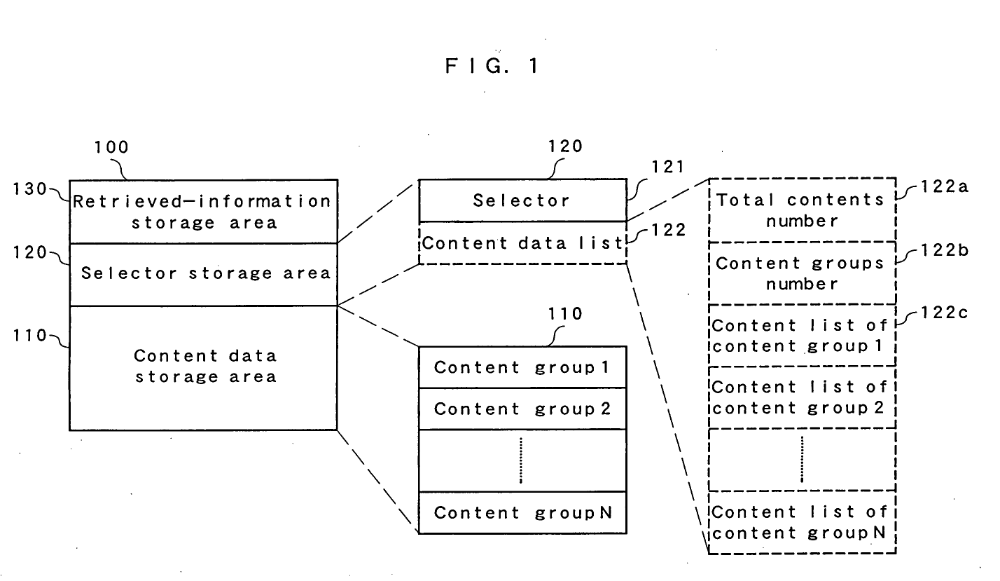

First, a first recording medium according to an embodiment of the present invention is described using FIGS. 1 to 4. FIG. 1 is an explanatory view showing an example of a data structure of a first recording medium 100. SD memory cards constitute the first recording medium 100. In this figure and later-described figures, a broken line part containing a content data list is shown as an optional part.

The first recording medium 100 has a content data storage area 110, selector storage area 120, and retrieved-information storage area 130. The content data storage area 110 is an area containing content groups. Herein, the content group refers to an assembly of one or more pieces of content data. In the example of FIG. 1, the content data storage area 110 contains N content groups, as shown with a content group 1, content group 2, . . . and content group N. Each of the N content groups conforms to the same specification and form. In this embodiment, each of the content groups stores each content data in a form conforming to the SD-AUDIO specification.

The selector storage area 120 contains a selector 121 as an information recording area for designating one specific content group among the N content groups stored in the content data storage area 110. In addition to this, the selector storage area 120 may contain a content data list 122. The content data list 122 is information concerning each content data contained in each of the content groups stored in the content data storage area 110.

The content data list 122 may contain part or all of the following items. Namely, the content data list 122 may contain the total contents number 122a, the content groups number 122b, and a content list 122c.

The total contents number 122a refers to the total number of pieces of content data stored in each of the content groups in the content data storage area 110. The content groups number 122b refers to the total number of content groups N (1≦i≦N). The content list 122c refers to a list of content data contained in each of the content groups.

The retrieved-information storage area 130 is an area for storing information needed when a data reproducing device or a data recording device extracts each content data stored in the content data storage area 110, the selector 121 stored in the selector storage area, and the like. This information includes a record address and size.

“SD Memory Card Specifications/Part 2 FILE SYSTEM SPECIFICATION/Ver1.01” specifies a file system specification for SD memory cards. In Embodiment 1, a FAT file system conforming to this specification is applied for controlling the record address and the like, and information needed in the FAT file system is recorded in the retrieved-information storage area 130.

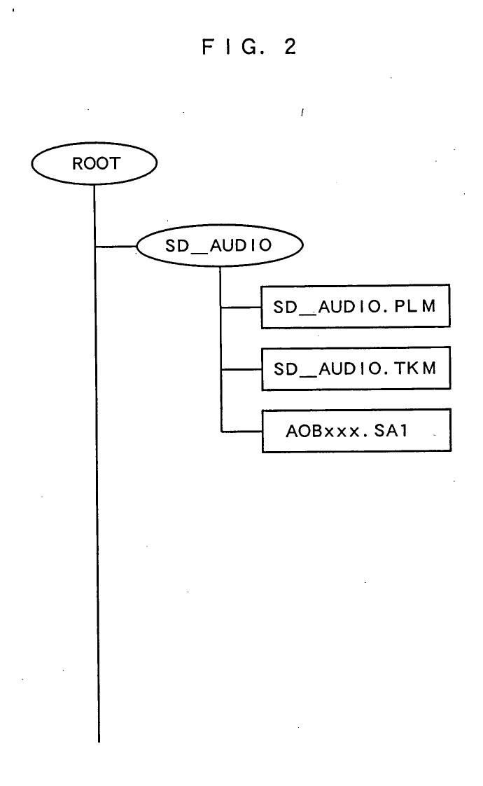

Herein, a difference in data structure between a conventional recording medium and the first recording medium in Embodiment 1 is described based upon a specific example. FIG. 2 is an explanatory view showing a data structure of the conventional recording medium.

FIG. 2 shows the data structure in the case of storing a content group conforming to the SD-AUDIO specification in a normal area (User Data Area) of the SD memory card. In FIG. 2, ovals show directories, and rectangles show files. In the SD-AUDIO specification, a directory “SD_AUDIO” is created immediately under a directory “ROOT”. Control files named “SD_AUDIO.PLM” and “SD_AUDIO.TKM”, and an encrypted content file “AOBxxx.SA1 (xxx are replaced by numbers from 011 to 999) are stored in this directory “SD_AUDIO”. One piece of content data is stored in one or more encrypted content files. Therefore, the SD-AUDIO is capable of storing 999 pieces of content data (tracks) at the maximum.

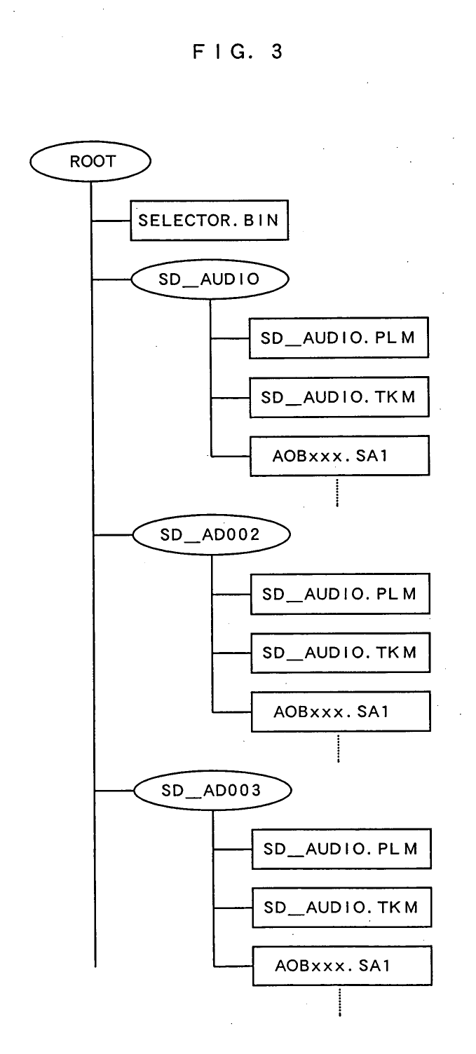

Meanwhile, FIG. 3 is an explanatory view of a data structure of the first recording medium 100 in Embodiment 1. FIG. 3 shows a data structure in the case of storing a plurality of content groups conforming to the SD-AUDIO specification in the normal area (User Data Area) of the SD memory card. In the example shown in FIG. 3, a directory “SD-AUDIO”, directory “SD_AD002” and directory “SD_AD003” are separately created immediately under a directly “ROOT”. As described later, a directory “SD_AD001” is renamed to the name of the directory “SD_AUDIO”. Files and directories created under these directories are in the same form as the files and directories created under the directory “SD_AUDIO” in the SD-AUDIO specification. Therefore, in this example, tracks in number three times as large as the number of tracks of the conventional recording medium, namely 2997 pieces of content data (tracks), can be stored.

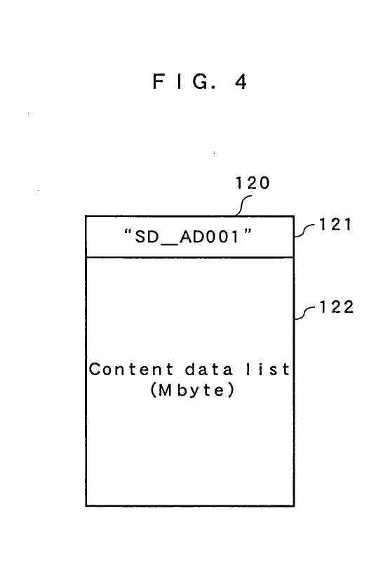

Further, FIG. 4 shows a constitutional example of the inside of a file “SELECTOR.BIN” created immediately under the directory “ROOT”. This file “SELECTOR.BIN” stores data of the selector storage area 120. The leading eight bytes of this file are the selector 121, and M bytes subsequent thereto are the content data list 122. In this example, the character string “SD_AD001” is stored in the selector 121, which means that the content group currently selected in FIG. 3 is “SD_AD001”. A substance of the content group is a file and directory stored under the directory “SD_AUDIO”. Namely, the substance of the content group selected by the selector 121 is always a file and directory stored under the directory “SD_AUDIO”. A character string of eight bytes to be stored in the selector 121 is a directory name of eight bytes named when a content group is selected. In this case, the character string of eight bytes is “SD_AD001”.

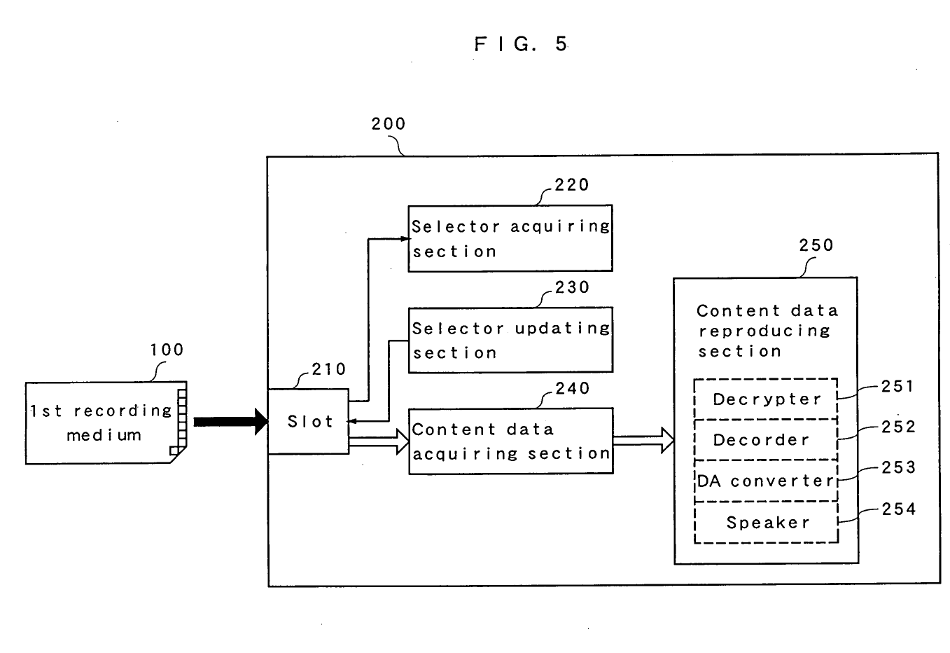

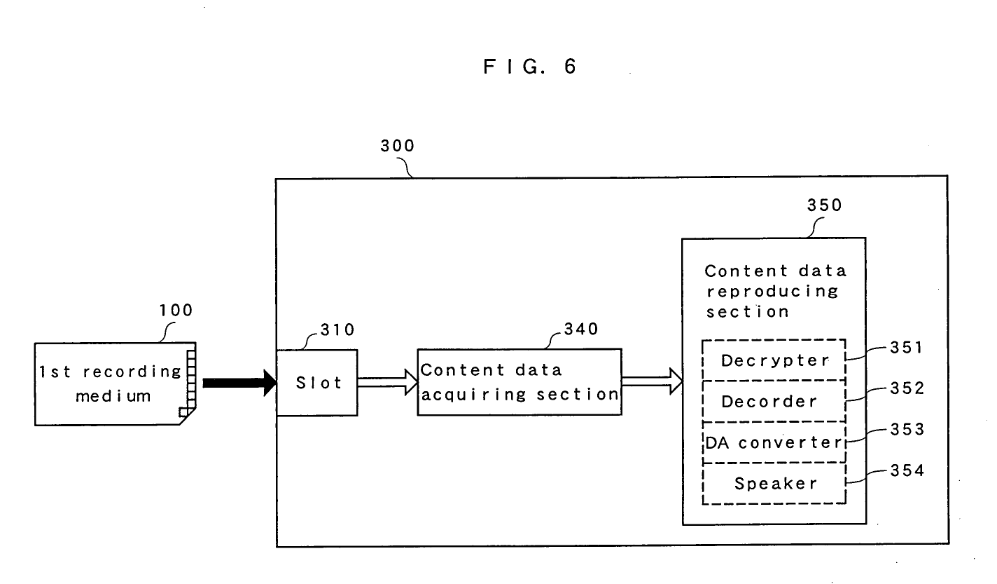

Next, a first data reproducing device in Embodiment 1 of the present invention is described using FIGS. 5 and 6. Herein, a thick arrowed line indicates a flow of the content data, and a thin arrowed line indicates a flow of the selector. FIG. 5 is a block diagram of a main part of a data reproducing device 200 in Embodiment 1 of the present invention.

The data reproducing device 200 includes a slot 210, selector acquiring section 220, selector updating section 230, content data acquiring section 240, and content data reproducing section 250. The slot 210 is a slot into which the first recording medium 100 is inserted. The selector acquiring section 220 acquires the selector 121 from the selector storage area 120 of the first recording medium 100 inserted into the slot 210. The selector updating section 230 updates the selector 121 acquired by the selector acquiring section 220. The content data acquiring section 240 reads content data contained in each of the content groups from the content data storage area 110 of the first recording medium 100. The content data reproducing section 250 converts the content data acquired by the content data acquiring section 240 for reproduction of the data.

The content data reproducing section 250 may include a decrypter 251 and decoder 252. The decrypter 251 decrypts content data when the data has been encrypted. The decoder 252 decodes content data when the data has been encoded. Further, the content data reproducing section 250 may include a DA converter 253 and speaker 254. The DA converter 253 converts content data as digital data into an analog signal. The speaker 254 outputs an audio signal having been converted into an analog signal by the DA converter 253. This speaker 254 involves electroacoustic transducers such as a headphone and earphone, and also involves analog output ports for these electroacoustic transducers.

In this embodiment, it is assumed that the content data reproducing section 250 of the data reproducing device 200 includes all of the decrypter 251, decoder 252, DA converter 253, and speaker 254. The data reproducing device 200 described above can be realized by installing a new functional program on functions of a conventional data reproducing device.

FIG. 6 is a block diagram showing a constitutional example of a conventional data reproducing device 300. This data reproducing device 300 includes a slot 310, content data acquiring section 340, and content data reproducing section 350. The slot 310 is a slot into which a conventional recording medium or the first recording medium 100 is inserted. The content data acquiring section 340 acquires each content data contained in the content groups stored in the content data storage area 110 from the first recording medium 100 inserted into the slot 310. The content data reproducing section 350 reproduces the content data acquired by the content data acquiring section 340.

The content data reproducing section 350 may include a decrypter 351 and decoder 352. The decrypter 351 decrypts content data when the data has been encrypted. The decoder 352 decodes content data when the data has been encoded. Further, the content data reproducing section 350 may include a DA converter 353 and speaker 354. The DA converter 353 converts content data into an analog signal. The speaker 354 outputs an audio signal having been converted into an analog signal by the DA converter 353.

In the following description, it is assumed that the content data reproducing section 350 includes all of the decrypter 351, decoder 352, DA converter 353, and speaker 354.

A constitutional difference between the first data reproducing device 200 in Embodiment 1 and the conventional data reproducing device 300 is whether or not to include the selector acquiring section 220 and the selector updating section 230 for performing operations of the selector stored in the first recording medium 100.

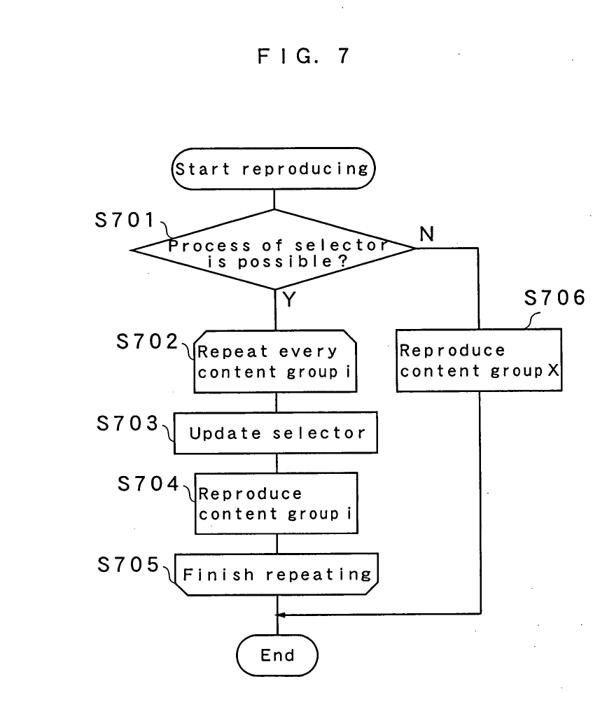

Next, a first data reproducing method in this embodiment is described using FIG. 7. FIG. 7 is an explanatory view showing an example of an operational sequence of the first data reproducing method. The sequence in FIG. 7 is started when a command to start reproduction is given in a state where the first recording medium 100 is inserted in the slot 210 of the first data reproducing device 200 in this embodiment or is inserted in the slot 310 of the conventional data reproducing device 300.

It is to be noted that the command to start reproduction may be given by a button operation by a user, or starting reproduction may be directed by detecting insertion of the first recording medium 100 in the data reproducing device.

When the first recording medium 100 is inserted or the command to start reproduction is outputted by the user, the data reproducing device 200 or 300 checks whether or not the selector is available in S701 of FIG. 7. The data reproducing device 300 is not capable of reading information of the selector 120 since having no selector acquiring section. In this case, the process is branched in S701 to a later-described process of S706.

In S701, when the data reproducing device, into which the first recording medium 100 has been inserted, determines that the selector 121 is processable, namely, when the data reproducing device is the first data reproducing device 200, the process steps to S702. When the selector 121 is not processable, the process steps to S706.

In S702, N content groups i (1≦i≦N) which are stored in the content data storage area 110 of the first recording medium 100 are sequentially subjected to processes after S703 in order.

It is assumed that the first recording medium 100 has three content groups as shown in FIG. 3. Namely, N=3, and values of selectors corresponding to the content groups 1 to 3 are character strings of eight bytes shown as “SD_AD001”, “SD_AD002” and “SD_AD003”, respectively.

Now, the case is considered where the value of the selector 120 is “SD_AD001”, and the user wishes anew to acquire content data of another directory. In this case, the selector updating section 230 needs to update the value of the selector 120.

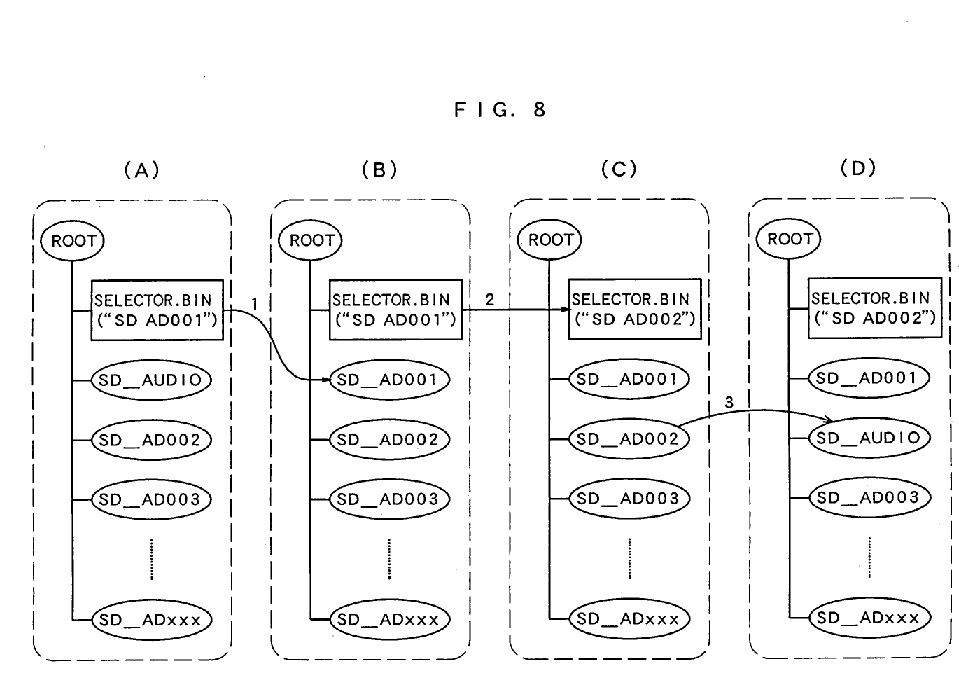

FIG. 8 is a view of state transition showing operations at updating the selector value. Herein, there is shown an example of updating the current selector value of “SD_AD001” to “SD_AD002”. In S703, the selector updating section 230 acquires “SD_AD001” as the current selector 121 via the selector acquiring section 220, as shown in (A) of FIG. 8. Thereafter, as shown in (B) of FIG. 8, the directory name of the content group currently selected is changed from “SD_AUDIO” to “SD_AD001” as the value of the current selector 121 (arrow 1).

Next, as shown in (C) of FIG. 8, the selector updating section 230 updates the value of the selector 121, “SD_AD001”, to a character string of eight bytes in correspondence with the content group i, e.g., “SD_AD002” (arrow 2). Then, as shown in (D) of FIG. 8, the directory name of the content group i (i=2) is changed to “SD_AUDIO” (allow 3).

In S704, the content data acquiring section 240 acquires content data of the content group i (i=2) selected by the selector 121. Specifically, the content data acquiring section 240 acquires content data under the directory “SD_AUDIO”. Each content data acquired by the content data acquiring section 240 is passed to the content data reproducing section 250. Inside the content data reproducing section 250, each content data is decrypted by the decrypter 251 and decoded by the decoder 252. The digital signal is then converted into an analog signal in the DA converter 253. In this manner, an audio signal is reproduced by the speaker 254.

When the reproduction of the content groups i is completed, the process steps to S705, and 1 is added to i. When the result of the addition is N (3 in this embodiment) or less, the process backs to S702, and data of another content group is reproduced. When N is 3, the reproducing process is completed.

On the other hand, when the data reproducing device 300 shown in FIG. 6 is in use, information of the selector storage area 120 is not readable even with use of the first recording medium 100. In this case, the process is branched in S701 to S706, and a content group having been selected by the selector in the current first recording medium 100 is set as the content group X to be a reproduced target. The content group X is stored in the directory “SD_AUDIO”. In this case, the content data acquiring section 340 of the data reproducing device 300 acquires content data of the content group X. Each content data of the content group X acquired by the content data acquiring section 340 is passed to the content data reproducing section 350.

Inside the content data reproducing section 350, each content data is decrypted by the decrypter 351 and decoded by the decoder 352. If the content data is not compressed as in the case of a compact disc (CD), but has been subjected only to error collect encoding and interleaving, the decoder 352 just performs decoding. If the content data has been subjected to data compression, error correction encoding and interleaving, the decoder 352 extends the data and decodes the extended data. This also applies to the following embodiments.

Next, the digital data is converted into an analog signal in the DA converter 353. In this manner, an audio signal is reproduced by the speaker 354. In the case of using the data reproducing device 300, the reproduction process is finished at the completion of the reproduction of the content group X.

Accordingly, using the first data reproducing method in this embodiment enables each content data contained in every content group stored in the first recording medium to be reproduced in the first data reproducing device 200. In addition to this, even in the conventional data reproducing device 300, each content data of the content group X previously designated by the selector 121 can be reproduced.

Further, in the data reproducing device 200 in this embodiment, every data can be reproduced only by changing the selector 121 of eight bytes stored in a file named “SELCTOR.BIN” and the directory name. Therefore, it is possible to readily realize the first data reproducing device 200 according to the present invention by installing a control program on the conventional data reproducing device.

It should be noted that the SD memory card has two recording areas: a user data area and an authentication area (Protected Area). Content data conforming to the SD-AUDIO specification is encrypted to be stored in the user data area, and key data used for the encryption is stored in the protected area. Therefore, when the content data conforming to the SD-AUDIO specification is to be reproduced, the key data stored in the protected area also needs to be processed. Since such a process can be realized in exactly the same manner as in the foregoing process on the content data, a description of this process is omitted.

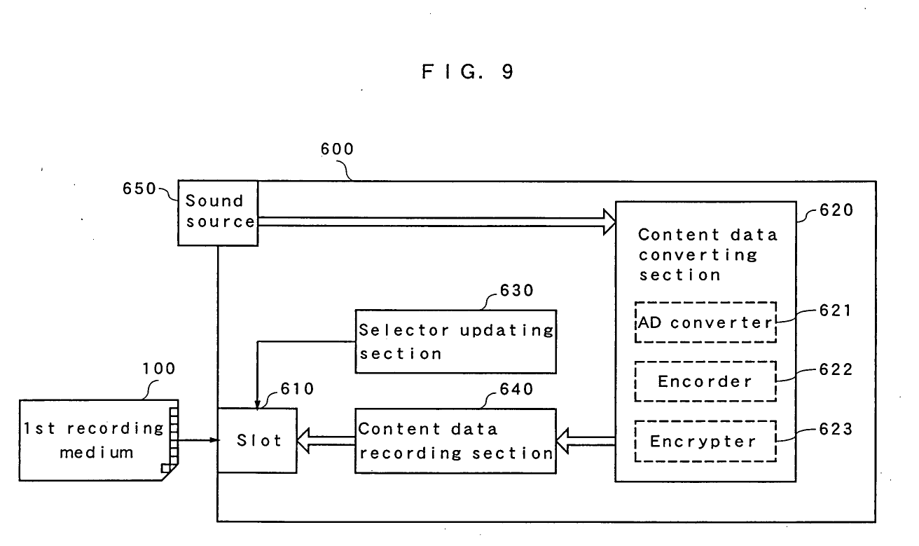

Next, a first data recording device for recording content data in the first recording medium 100 is described. FIG. 9 is a block diagram of a main part of a first data recording device 600. The first data recording device 600 includes a slot 610, content data converting section 620, selector updating section 630, and content data recording section 640. The slot 610 is a slot into which the first recording medium 100 is inserted. The content data converting section 620 extracts content data from an external sound source 650, such as a CD or music file, and converts the data into data conforming to the SD-AUDIO specification. At the time of recording the content data, the selector updating section 630 updates selector information in the selector storage area 120 of the first recording medium 100 inserted into the slot 610. The content data recording section 640 records content data, given from the content data converting section 620, in the first recording medium 100.

The content data converting section 620 has an AD converter 621, encoder 622, and encryptor 623. When a signal form of a content to be inputted into the first data recording device 600 is an analog audio signal, the AD converter 620 converts the signal into digital data. The encoder 622 compresses content data of a PCM or data given from the AD converter 621, to be encoded. The encryptor 623 encrypts the encoded data in a manner conforming to the SD-AUDIO specification.

A recording operation in the first data recording device 600 as thus constituted is described. In the root directory shown in FIG. 3, first, a directory in which recording is to be made is determined. The method for the determination is not restricted, and directories may be selected in order of the directory names, or a new directory may be created. Herein, the case of selecting “SD_AD003” is described.

First, using the selector updating section 630, a directory in which recording is to be made is selected from the selector storage area 120 in FIG. 1. Hence, the current name of the directory “SD_AUDIO” is changed back to the name stored in the selector 121. Next, “SD_AD003” is stored in the selector 121. In this manner, the name of the directory “SD_AD003” is changed to “SD_AUDIO”.

Then, content data is inputted from the external sound source 650 to be given to the content data converting section 620. The data is compressed to be coded by the encoder 622, and then is encrypted by the encryptor 623. This data is then recorded by the content data recording section 640 in the directory selected by the selector 120, herein, the directory “SD_AUDIO”. If the directory is filled during recording, another directory in which recording is to be made is determined and the same operation is continued.

Herein, explanation is given of a processing method (No. 1) in the case where content data to be recorded cannot be housed in one content group. In the SD_AUDIO specification, 999 encrypted content files can be stored. It is to be noted that one musical composition, namely one piece of content data, is pot necessarily storable in one encrypted content file. For example, in the case of checking out music composition data from a personal computer (PC) to a recording medium, whether or not the remaining encrypted content files are sufficient in number is checked in the directory “SD_AUDIO” every time one musical composition is recorded. When the files are deficient in number, a new directory is searched for. Whether or not the encrypted content files are sufficient in number may not be seen prior to recording of music compositions. For example, a case where a musical composition is recorded through an external equipment other than a PC corresponds to this case. In such a case, music compositions may be recorded until filling the 999 files, and then another directory may further be searched.

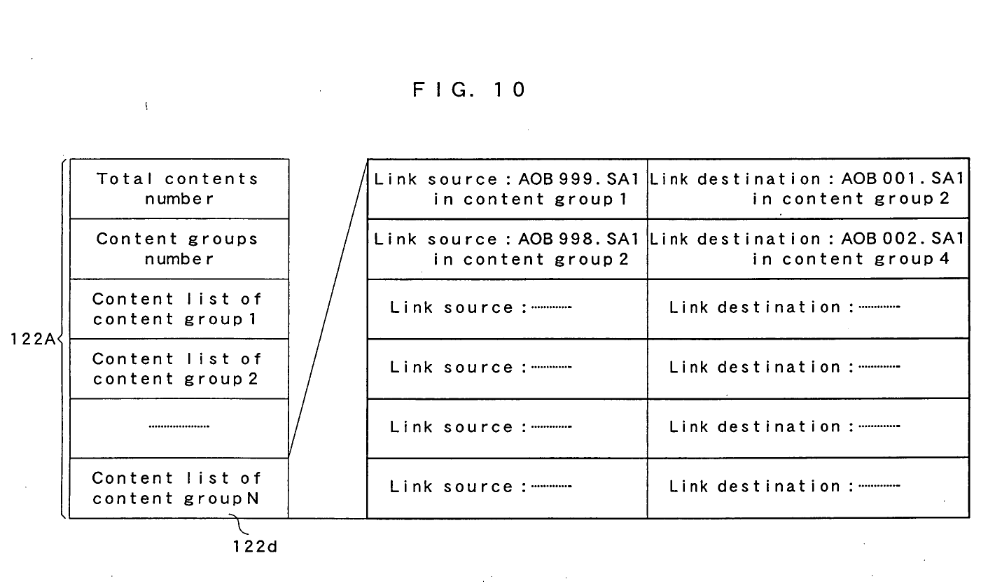

Next, explanation is given of a processing method (No. 2) in the case where content data cannot be stored in one content group. In this case, a new area for storing content link list information is provided in the content data list 122 of the selector storage area 120 shown in FIG. 1. FIG. 10 shows an example about this. This content data list 122A has a link list 122d of content groups adding to information of the content data list 122 shown in FIG. 1. If content data cannot be stored in the content group X, a content group Y as a link destination is recorded with respect to the content group X as a link source. FIG. 10 shows an example where the content group 1 “AOB999.SA1” as a link source is linked to the content group 2 “AOB001.SA1” as a link destination. In such a manner, recording of one piece of content data over different content groups is recorded in the link list. As thus described, when one whole piece of content data cannot be recorded in the content group 1, the unrecorded portion of the data is sequentially recorded in the content group 2. Also in the case of reproduction, the link list is referred to so that content data recorded over a number of files can be reproduced.

It should be noted that the above embodiment does not restrict the present invention, and may be implemented or modified without departing from the spirit and scope of the present invention. The following cases are also included in the technical concept of the present invention.

(1-1) Although the number (N) of content groups stored in the first recording medium 100 was 3 in this Embodiment, the number N is not restricted so long as it is one or more integers.

(1-2) Although the content groups conforming to the SD-AUDIO specification were described in this embodiment, the present invention is not restricted to such content groups. The present invention is effective so long as a recording medium stores content groups controlled in conformity with a certain form. Further, the recording medium is not restricted to the SD memory card, and may be another semiconductor memory, optical disk, magnetic disk, or combination of these disks. For example, the recording medium may be a pseudo-SD memory card with an extremely large capacity, formed by combination of an SD memory card and a hard disk.

(1-3) Although the FAT file system was used in the retrieved-information storage area 130 in this embodiment, another file system, such as a UDF, may be used. Further, a record address may be controlled without using the file system.

(1-4) Although the method for reproducing all content groups contained in the first recording medium 100 in the first data reproducing device 200 was described in this embodiment, all the contents are not necessarily required to be reproduced.

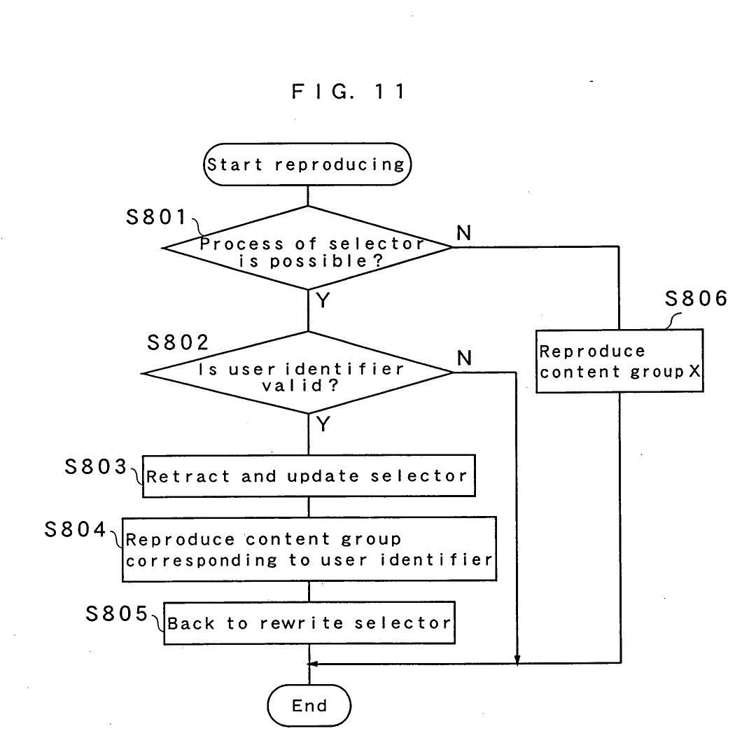

Further, in the case where the first data reproducing device 200 is capable of using a user identifier given to every user, it is possible to reproduce only a content in correspondence with the user, as shown in FIG. 11. Herein, the user identifier is a character string of eight bytes for identifying an individual user. The user identifier is brought into one-to-one correspondence with the content group, and used as the selector. The user designates a user identifier to the first data reproducing device 200 at an arbitrary timing, e.g., at the beginning of using the device. Herein, the data reproducing device 200 stores therein the user identifier designated by the user.

Herein, an operation of the first data reproducing device 200 in the case where the user identifier is available is described using FIG. 11. It is assumed that the user identifier is to be recorded in the selector storage area 120 of the recording medium. In S801, the data reproducing device, in which the first recording medium 100 is inserted, determines whether or not the selector 121 is processable. When the selector 121 is processable, the process steps to S802. When the selector 121 is not processable, the process steps to S806. Specifically, when the data reproducing device in which the first recording medium 100 is inserted is the first data reproducing device 200, the process steps to S802, while when the reproducing device is the conventional data reproducing device 300, the process steps to S806.

In S802, the first data reproducing device 200 determines whether or not the user identifier is valid, namely, the user identifier is available. When it is determined that information of the user identifier is valid as a value of the selector 121, the process steps to S803. The term “valid” herein means that a content group in correspondence with the user identifier is present in the first recording medium 100. If the information of the user identifier is not valid, the process is ended.

In S803, the selector updating section 230 acquires the current selector 121 via the selector acquiring section 220, and,retracts the content of the selector 121 inside. Thereafter, the directory name of the content group currently selected is changed from “SD_AUDIO” to the value of the current selector 121.

Next, the selector updating section 230 updates the value of the selector 121 to the value of the user identifier acquired in S802, and changes the directory name of the content group i corresponding to the user identifier to the “SD_AUDIO”.

In S804, the content data acquiring section 240 acquires each content data in the content group i (1≦i≦N) corresponding to the selector 121. Specifically, the content data acquiring section 240 acquires content data under the directory “SD_AUDIO”. The content data acquired by the content data acquiring section 240 is passed to the content data reproducing section 250. Inside the content data reproducing section 250, each content data is decrypted by the decrypter 251, and then is decoded by the decoder 252. Then, the DA converter 253 converts digital data into an analog signal. Thus, an audio signal is reproduced by the speaker 254.

In S805, at the completion of the reproduction, the directory name of the content group i currently selected is changed from “SD_AUDIO” to the value of the current user identifier, namely, the value stored in the selector 121.

Next, the selector updating section 230 updates the value of the selector 121 to the value retracted in S803, and changes the directory name of the content group corresponding to the selector 121 to “SD_AUDIO”.

When the process steps from S801 to S806, a content group being selected by the current selector is referred to as a content group X. The content group X is stored in the directory “SD_AUDIO”. The content data acquiring section 240 acquires content data of the content group X. The content data acquired by the content data acquiring section 240 is passed to the content data reproducing section 250. Inside the content data reproducing section 250, each content data is decrypted by the decrypter 251, and then is decoded by the decoder 352. Then, the DA converter 353 converts digital data into an analog signal. Thus, an audio signal is reproduced by the speaker 354. The reproduction process is finished at the completion of the reproduction of the content group X.

Therefore, in the case of using the first data reproducing device 200, a content group corresponding to a user identifier can be reproduced. In the case of using the conventional data reproducing device 300, a (default) content group X previously designated by the selector 121 can be reproduced. When the same first recording medium 100 is used by a plurality of users, it is possible to readily switch content groups according to the users.

(1-5) Although the example of not using the content data list 122 was described in this embodiment, using the content data list 122 makes the following possible.

Since each of the content groups stored in the first recording medium 100 is stored in a form conforming to a conventional specification or the like, each content group may have control information of each content data contained in the content group. However, in the absence of control information that has control over a plurality of content groups, it is necessary, for creating a play list including contents of a plurality of content groups, to analyze content data or a control file contained in each content group, which is a complicated process. Herein, the play list is information on the reproducing order of content data.

Thereat, previously creating a list of content data stored in each content group as a content data list 122 permits the first data reproducing device 200 to easily handle content data of a plurality of content groups. Therefore, the content data list 122, where information on content data stored in each content group is put together, may be stored in the selector storage area 120.

### Embodiment 2

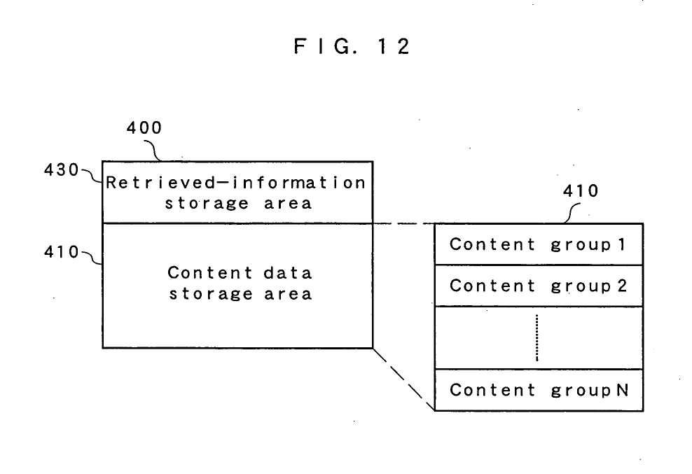

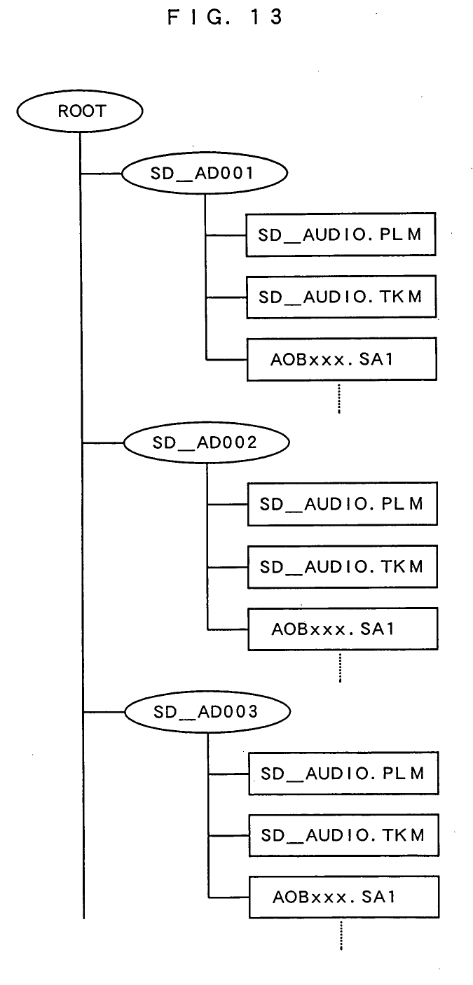

Next, a second recording medium in Embodiment 2 of the present invention is described using FIGS. 12 and 13. The recording medium of this embodiment has a feature in that a selector storage area as in Embodiment 1 is not provided. A data reproducing method and data recording method in such a case are described.

FIG. 12 is an explanatory view showing an example of a data structure of a second recording medium 400 as an SD card. The second recording medium 400 has a content data storage area 410 and retrieved-information storage area 430.

The content data storage area 410 contains at least one content group. Herein, the content group refers to an assembly of one or more pieces of content data. In the example of FIG. 12, the content data storage area 410 contains N content groups, as shown with a content group 1, content group 2, . . . and content group N. Each of the N content groups conforms to the same specification and form. In this embodiment, it is assumed that each of the content groups stores each content data in a form conforming to the SD-AUDIO specification.

The retrieved-information storage area 430 is an area for storing information needed when a data reproducing device or data recording device extracts each content data stored in the content data storage area 410. This information includes a record address and size.

In Embodiment 2, a record address and the like are control by a FAT file system conforming to “SD Memory Card Specifications/Part 2 FILE SYSTEM SPECIFICATION/Ver1.01” which specifies a file system specification for SD memory cards. Further, information needed in the FAT file system is recorded in the retrieved-information storage area 430.

FIG. 13 is an explanatory view of a data structure of the second recording medium 400 in Embodiment 2. In particular, FIG. 13 shows the data structure in the case of storing content groups conforming to the SD-AUDIO specification in a normal area (user data area) of the SD memory card. In FIG. 13, a directory “SD_AD001”, directory “SD_AD002”, and directory “SD-AD003” are created immediately under a directory “ROOT”. Files and directories created under these directories are in the same form as the files and directories created under the directory “SD_AUDIO” in the SD-AUDIO specification. Therefore, in this example, tracks in number three times as large as the number of tracks of the conventional recording medium, namely 2997 tracks, can be stored.

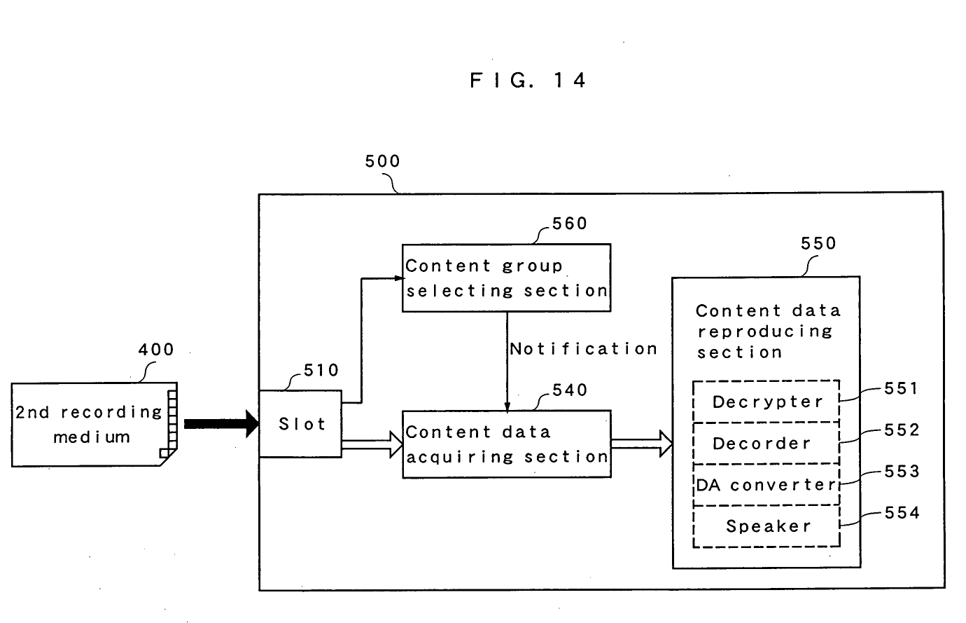

Next, a second data reproducing device in Embodiment 2 is described using FIG. 14. FIG. 14 is a block diagram of a second data reproducing device 500. The second data reproducing device 500 includes a slot 510, content group selecting section 560, content data acquiring section 540, and content data reproducing section 550. The slot 510 is a slot into which the second recording medium 400 is inserted. The content group selecting section 560 selects one of each content group stored in the content data storage area 410 of the second recording medium 400 inserted into the slot 510. The content data acquiring section 540 reads each content data contained in each of the content groups from the content data storage area 410 of the second recording medium 400. The content data reproducing section 550 reproduces the content data acquired by the content data acquiring section 540.

The content data reproducing section 550 may include a decrypter 551 and decoder 552. The decrypter 551 decrypts content data when the data has been encrypted. The decoder 552 decodes content data when the data has been encoded. Further, the content data reproducing section 550 may include a DA converter 553 and speaker 554. The DA converter 553 converts content data as digital data into an analog signal. The speaker 554 reproduces an audio signal having been converted into an analog signal by the DA converter 553.

A constitutional difference between the second data reproducing device 500 in this embodiment and the conventional data reproducing device 300 is whether or not there exists the content group selecting section 560 for selecting one of content groups stored in the second recording medium 400.

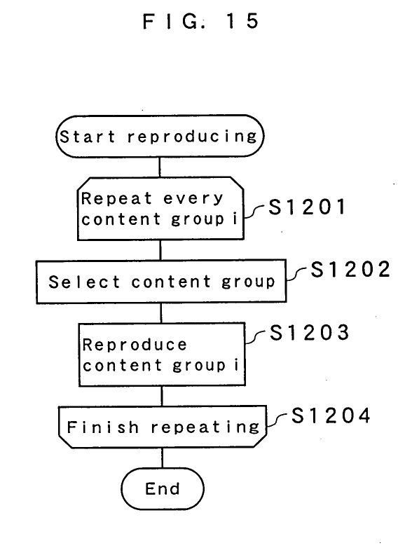

Next, a second data reproducing method according to this embodiment is described using FIG. 15. FIG. 15 is an explanatory view showing an example of an operational sequence of the second data reproducing method in this embodiment. The process in FIG. 15 is started when a command to start reproduction is given in a state where the second recording medium 400 is inserted into the slot 510 of the second data reproducing device 500. It is to be noted that the command to start reproduction may be given by a button operation by the user, or given in the second data reproducing device by detecting insertion of the second recording medium 400 in the second data reproducing device.

In the following, a detail of each step is described. In S1201, a process is repeated on N content groups i (1≦i≦N), stored in the content data storage area 410 of the second recording medium 400, until i becomes N.

In this embodiment, the second recording medium 400 has three content groups as shown in FIG. 13. The content groups corresponding to the content groups 1 to 3 are respectively stored in directories “SD_AD001”, “SD_AD002” and “SD_AD003”.

In S1202, the content group selecting section 560 selects the content group i, and notifies the selection result to the content data acquiring section 540.

A method for recognizing the content group i is described herein. First, the content group selecting section 560 searches a directory immediately under the root directory. If the presence of control files named “SD_AUDIO.PLM”, “SD_AUDIO.TKM” is revealed in the search, this directory is recognized as a content group to be reproduced. This is one example for the recognizing method. In order to increase accuracy of the search, contents of the control files “SD_AUDIO.PLM”, “SD_AUDIO.TKM” is read to confirm whether or not the contents conform to the SD_AUDIO specification. This allows the data reproducing device 500 of this embodiment to also reproduce the conventional recording medium only having the SD_AUDIO folder.

In S1203, the content data acquiring section 540 acquires each content data of the content group i selected by the content group selecting section 560, and passes the data to the content data reproducing section 550. Inside the content data reproducing section 550, each content data is decrypted by the decrypter 551, and then is decoded by the decoder 552. Then, the DA converter 553 converts digital data into an analog signal. Thus, an audio signal is reproduced by the speaker 554.

When the reproduction of the content groups i is completed, in S1204, 1 is added to i. When the result of the addition is N (3 in this embodiment) or less, the process backs to S1201, and when the result is not N or less, the reproducing process is completed.

Accordingly, using the second data reproducing method in this embodiment enables each content data contained in every content group stored in the second recording medium to be reproduced in the second data reproducing device 500.

Moreover, in this embodiment, since the content group selecting section 560 simply designates each content group in turn, the second data reproducing device 500 can be realized just by installing a simple control program.

It should be noted that the SD memory card has two recording areas: a user data area and an authentication area (Protected Area). Content data conforming to the SD-AUDIO specification is encrypted to be stored in the user data area, and key data used for the encryption is stored in the protected area.

Therefore, when the content data conforming to the SD-AUDIO specification is to be reproduced, the key data stored in the protected area also needs to be processed. Since such a process can be realized in exactly the same manner as in the foregoing process on the content data, a description of this process is omitted.

It is to be noted that the second recording medium 400 may be used for the conventional data reproducing device 300. If the second recording medium 400 is inserted in the data reproducing device 300, only the directory “SD_AUDIO” immediately under the root directory becomes reproducible. If the directory “SD_AUDIO” is not present immediately under the root directory, no data is reproducible.

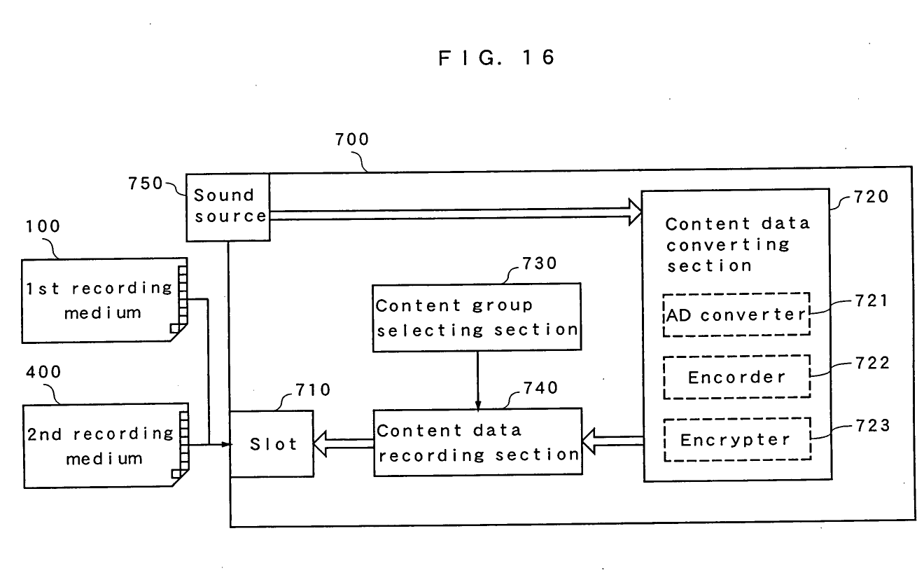

Next, explanation is given of a second data recording device capable of recording content data in the first recording medium or second recording medium. FIG. 16 is a block diagram of a main part of a second data recording device 700. The second data recording device 700 includes a slot 710, content data converting section 720, content group selecting section 730, and content data recording section 740. The slot 710 is a slot into which the first recording medium 100 or second recording medium 400 is inserted. The content data converting section 720 extracts content data from an external sound source 750, such as a CD or music file, and converts the data into data conforming to the SD-AUDIO specification. The content group selecting section 730 directly selects a directory of a content group in the content data storage area 110 of the first recording medium 100 or a content data storage area 410 of the recording medium 400. The content data recording section 740 records content data, given from the content data converting section 720, in the first recording medium 100 or second recording medium 400.

As in the case of the content data converting section 620 of the first data recording device 600, the content data converting section 720 has an AD converter 721, encoder 722, and encryptor 723. Further, the content group selecting section 730 has the same function as that of the content group selecting section 560 in the second data reproducing device 500.

A recording operation in the second data recording device 700 as thus constituted is described. In order to identify the content of the format of the recording medium inserted into the slot 710, the second data recording device 700 checks the root directory to confirm the presence or absence of the file SELECTOR.BIN, as shown in FIG. 3. When the file SELECTOR.BIN is present, the presence of the selector of the selector storage area 120 as shown in FIG. 1 is recognized, so that it is determined that the first recording medium 100 has been inserted into the slot 710. For recording content data in this case, the directory “SD_AUDIO” is not selected, but the content group selecting section 730 has access to the content data storage area 110 to open a directory of a desired content group. Then, content data is recorded in this directory.

When the file SELECTOR.BIN is not present in the root directory of the inserted recording medium, the recording medium is recognized as the second recording medium 400. In this case, as in the above-mentioned case, the content group selecting section 730 has access to the content data storage area 110 to open a directory of a desired content group. Then, content data is recorded in the directory. Therefore, when the data is to be recorded on the first data reproducing device 600, a directory of a desired content group is converted into the directory “SD_AUDIO”, and then recording is made. In the meantime, in the second data recording device 700, the content group selecting section 730 directly selects a directory of a desired content group, and then recording is made.

Herein, explanation is given of the compatibility between a recording medium formatted in the current file system, e.g., an SD card, and the first recording medium 100 and second recording medium 400 used in the present invention. In order to hold the compatibility of the recording medium between the conventional data reproducing device and the data reproducing device of the present invention, file system layers and physical layer of those devices need to be uniform. The SD_AUDIO specification is held based upon the SD_File system specification and the SD_Physical specification.

Herein, the recording medium and the data reproducing device in Embodiment 2 are compared with the recording medium and the data reproducing device in Embodiment 1. The advantage of Embodiment 2 is that there is no need to write select data in the data reproducing device since the selector is not present on the recording medium. In this case, the development of the data reproducing device is facilitated. The disadvantage of Embodiment 2 is that the first content group to be reproduced might be different in each reproducing device since the selector is not present on the recording medium. It is to be noted that, in the second recording medium, one content group may be named the directory “SD_AUDIO” so as to be preferentially reproduced. In this case, when the content group named “SD_AUDIO” is replaced, a new rule needs to be set. When the selector is not present, the directory has no old name, which might cause prevention of simple cancellation of select.

It should be noted that, although the present invention has been described based upon the above embodiment, this embodiment does not restrict the present invention, and may be implemented or modified without departing from the spirit and scope of the present invention. The following cases are also included in the present invention.

(2-1) Although the number N of content groups stored in the second recording medium 400 was 3 in this embodiment, the number N is not restricted so long as it is one or more integers.

(2-2) Although the content groups conforming to the SD-AUDIO specification were described in this embodiment, the present invention is not restricted to such content groups. The present invention is effective so long as a recording medium stores content groups controlled in conformity with a certain form. Further, the recording medium is not restricted to the SD memory card, but may be another semiconductor memory, optical disk, magnetic disk, or combination of these disks. For example, the recording medium may be a pseudo-SD memory card with an extremely large capacity formed by combination of the,:SD memory card and a hard disk.

(2-3) Although the FAT file system was used in the retrieved-information storage area 430 in this embodiment, another file system, such as a UDF, may be used, or a record address may be controlled without using the file system.

(2-4) Although the method for reproducing all content groups contained in the second recording medium 400 in the second data reproducing device 500 was described in this embodiment, all the contents are not necessarily required to be reproduced.

Further, in the case where the second data reproducing device 500 is capable of using a user identifier given to every user, the content group selecting section 560 may have the function of selecting a content group in agreement with a user identifier to reproduce the content group. It should be noted that, in this embodiment, a user identifier is put down with the number i of the content group. The second data reproducing device 500 according to the present invention is capable of reproducing a content group in correspondence with a user identifier, and when the same second recording medium 400 is used by a plurality of users, it is possible to readily switch content groups according to the users.

(2-5) Although the example was shown in this embodiment where a reproducible content group even in the conventional data reproducing device is not stored in the second recording medium 400, the directory named “SD_AUDIO” may be stored as in Embodiment 1. In this case, the second recording medium 400 can be reproduced in the conventional data reproducing device.

(2-6) Although the second data reproducing method was described using the second recording medium 400 and the second data reproducing device 500 in this embodiment, the second data reproducing method may be effective even in the case of combining the first recording medium 100 with the second data reproducing device 500.

### INDUSTRIAL APPLICABILITY

According to the present invention, it is possible to store content data in number not smaller than the number of data that can be handled in a conventional specification. The recording medium of the present invention can be read even in a conventional data reproducing device, let alone in a new data reproducing device. Further, with the use of the data reproducing device of the present invention, it is possible to resolve the disadvantage of the user owing the conventional data reproducing device, and also realize smooth extension of a conventional specification. Such a technique can be preferably used for a portable recording/reproducing device (solid player) for recording or reproducing a number of musical compositions.

1. A recording medium comprising:
a content data storage area which stores at least one of content groups conforming to an identical form;
a selector storage area which stores selector information for designating one of said content groups; and
a retrieved-information storage area which stores information including a record address needed when a data reproducing device extracts said content group and said selector information.

2. The recording medium according to claim 1, wherein
said selector storage area further stores a content data list as a list of each content data contained in each content group stored in said content data storage area.

3. The recording medium according to claim 1, wherein
each of the content groups stored in said content data storage area is brought into one-to-one correspondence with a user identifier for identifying an individual user, and
said selector storage area stores said user identifier as the selector information.

4. The recording medium according to claim 1, wherein
each of the content groups stored in said content data storage area is stored in a form conforming to an SD-AUDIO specification.

5-7. (canceled)

8. A data reproducing device comprising:
a slot into which a recording medium is inserted;
a selector acquiring section which acquires a selector from a selector storage area of said recording medium inserted into said slot;
a selector updating section which updates the selector acquired from said selector acquiring section, in conformity with a content group to be reproduced;
a content data acquiring section which acquires content data contained in each of content groups from the content data storage area of said recording medium; and
a content data reproducing section which reproduces the content data acquired by said content data acquiring section, wherein
said recording medium includes: a content data storage area which stores at least one of content groups conforming to an identical form; a selector storage area which stores selector information for designating one of said content groups; and a retrieved-information storage area which stores information including a record address needed when the data reproducing device extracts said content group and said selector information.

9. (canceled)

10. A data reproducing method for reproducing data stored in a content data storage area of a recording medium, includes the following steps of:
writing information showing said content groups as a selector into said selector storage area; and
extracting content data of each of the content groups selected by said selector from said content data storage area, and then reproducing the content data,
when said recording medium includes a content data storage area which stores at least one of content groups conforming to an identical form, a selector storage area which stores selector information for designating one of said content groups, and a retrieved-information storage area which stores information including a record address needed when a data reproducing device extracts said content group and said selector information.

11. The data reproducing method according to claim 10, further includes the following steps of:
retracting selector information of said recording medium when a user identifier is given by the user, and then updating the given user identifier as new selector information;
reproducing only content data of a content group corresponding to the given user identifier; and
backing to rewrite said retracted selector information after the reproduction,
when each of the content groups stored in said content data storage area of said recording medium is brought into one-to-one correspondence with a user identifier for identifying an individual user and said user identifier is stored in said selector storage area as selector information.

12-13. (canceled)

14. A data recording device comprising:
a slot into which a recording medium is inserted;
a selector updating section which acquires a selector from a selector storage area of said recording medium inserted into said slot and, also, updates said selector in conformity with a content group to be recorded;
a content data converting section which inputs content data and converts the inputted data into a content group including a file conforming to a specification of said recording medium; and
a content data recording section which records data of the content group in the content data storage area of said recording medium, wherein
said recording medium includes: the content data storage area which stores at least one of content groups conforming to an identical form; a selector storage area which stores selector information for designating one of said content groups; and a retrieved-information storage area which stores information including a record address needed when a data reproducing device extracts said content group and said selector information.

15. (canceled)
